(19) United States
(12) Patent Application Publication
(10) Pub. No.: US 2005/0097571 A1
(43) Pub. Date: May 5, 2005

(54) Event management system and method

(75) Inventor: David Uguccioni, Richmond Hill (CA)

Correspondence Address: BERESKIN AND PARR, 40 KING STREET WEST, BOX 401, TORONTO, ON, M5H 3Y2, CA

(73) Assignee: Partner Marketing Works International Inc., Richmond Hill (CA)

(21) Appl. No.: 10/980,286

(22) Filed: Nov. 4, 2004

Related U.S. Application Data
(60) Provisional application No. 60/516,873, filed on Nov. 4, 2003.

(51) Int. Cl. H04M 7/00; G06F 3/00; G06F 9/46; G06F 9/44; G06F 13/00

(52) U.S. Cl. 719/318

(57) ABSTRACT

An event management system and method for managing an event offering over a communication network, where the event offering is directed at a customer by a vendor through a partner. The event management system includes a vendor interface module, a partner interface module and a portal server. The vendor interface module allows the vendor to post an event offering on the portal server over the communication network. The partner interface module allows the partner to associate a number of operational characteristics with the event offering over the communication network. The portal server generates a customized event offering based on the operational characteristics such that the customized event offering reflects the partner's identity. Finally, the portal server provides the partner with the ability to manage the customized event over the communication network through automated means.

This application claims the benefit under 35 U.S.C. 119(e) of U.S. Provisional Application No. 60/516,873, filed Nov. 4, 2003.

### FIELD OF THE INVENTION

This invention relates generally to scheduling systems and methods and more particularly to a system and method for automating the management process for organizing events.

### BACKGROUND OF THE INVENTION

Commercial entities routinely provide their employees or prospective customer s with educational and promotional event programs. The organization of these events can be overwhelming especially when a large number of events are being provided. Typically, a troublesome and time-consuming aspect of the organization of an event is in managing the execution logistics. These tasks include scheduling, planning, promoting, reserving event places for interested attendees, monitoring enrollment, sending reminders, confirming attendance, ensuring consistent messaging and measuring performance.

Most commercial event programs are organized by organizations using manual means. These manual activities typically include the identification of prospective registrants/attendees, the production and distribution of invitations by e-mail and/or surface mail and tracking registrations from prospective attendees. Since these activities require human intervention on virtually every level, event planning can be inconsistently executed and the organizational quality of the resulting event program can be adversely affected. Any ad hoc approach is also subject to human error that can negatively affect the overall success of the event programs on a longer-term basis. Accordingly, there is a need for a streamlined process for event planning and execution that ensures the quality and consistency of all event offerings from an organization.

A number of prior art automated direct mail systems are currently available such as The Wilshire Group (at www.wilshiregroup.com), Channel Wave (at www.channelwave.com), Purplewire, LLC (www.channelsuite.com), and Siebel Systems Inc. (www.siebel.com). However, they do not provide functionality for event program planning purposes.

### SUMMARY OF THE INVENTION

The invention provides in one aspect, a method of managing an event offering over a communication network, said event offering being directed at a customer by a vendor through a partner, said method comprising:
(a) obtaining an event offering over the communication network from the vendor, said event offering having a plurality of operational characteristics;
(b) obtaining operational characteristics for the event offering from the partner over the communication network;
(c) generating a customized event offering based on the operational characteristics such that the customized event offering reflects the partner's identity; and
(d) providing the partner with the ability to manage said customized event over the communication network.

In another aspect, the invention provides an event management system for managing an event offering over a communication network, said event offering being directed at a customer by a vendor through a partner, said system comprising:
(a) a vendor interface module for obtaining an event offering over the communication network from the vendor, said event offering having a plurality of operational characteristics;
(b) a partner interface module for obtaining operational characteristics for the event offering from the partner over the communication network;
(c) a portal server for:
   (i) generating a customized event offering based on the operational characteristics such that the customized event offering reflects the partner's identity; and
   (ii) providing the partner with the ability to manage said customized event over the communication network.

Further aspects and advantages of the invention will appear from the following description taken together with the accompanying drawings.

### BRIEF DESCRIPTION OF THE DRAWINGS

In the accompanying drawings:

FIG. 1 is block diagram of the event management system of the present invention;

FIG. 2 is a flowchart illustrating the general operational process steps of the event management system of FIG. 1;

FIG. 3 is a flowchart illustrating the process steps of the VENDOR ADMINISTRATIVE SETUP routine that is executed by the event management system for the vendor administrator of FIG. 1;

FIGS. 4A, 4B, 4C, 4D, 4E, 4F and 4G are screen captures of the vendor administrator interface of the event marketing system of FIG. 1;

FIG. 5 is a flowchart illustrating the process steps of the PARTNER SETUP routine that is executed by the event management system for the partner of FIG. 1;

FIG. 6A, 6B, 6C, 6D, 6E, 6F, 6G, 6H and 6I are screen captures of the partner interface of the event marketing system of FIG. 1;

FIG. 7 is a flowchart illustrating the process steps of the EVENT MANAGEMENT routine that is executed by the event management system of FIG. 1;

FIG. 8A, 8B, 8C, 8D, 8E, 8F, 8G, and 8H are screen captures of the customer interface of the event marketing system of FIG. 1;

FIG. 9 is a flowchart illustrating the process steps of the CUSTOMERREGISTRATION routine that is executed by the event management system for the customer s of FIG. 1; and

FIG. 10A, 10B, 10C, 10D, 10E, and 10F are screen captures of the customer interface of the event marketing system of FIG. 1.

### DETAILED DESCRIPTION OF THE INVENTION

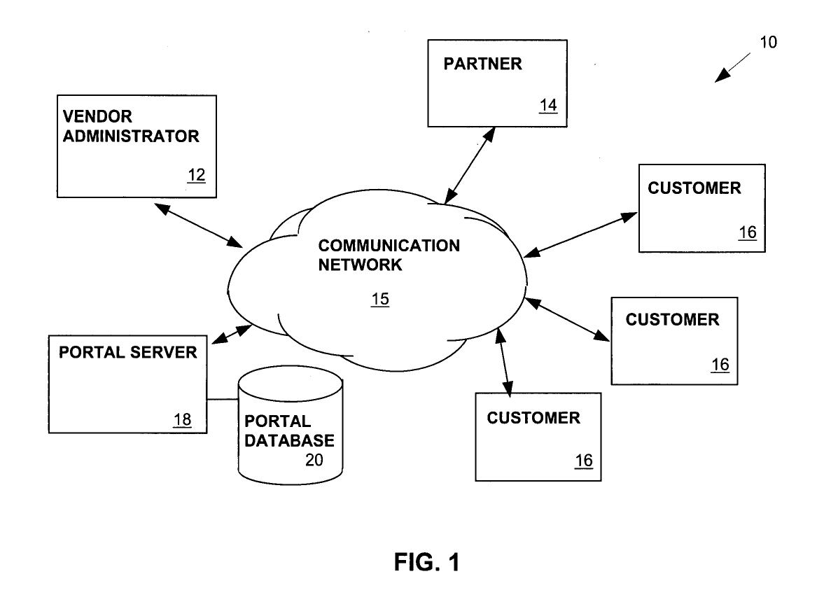

Reference is first made to FIG. 1, which shows a block diagram of the event management system 10 made in accordance with a preferred embodiment of the present invention. Event management system 10 allows a vendor administrator 12 to provide a customized event program to a partner 14. The partner 14 can in turn provide their customer s 16 with a fully administered event program over communications network 15. Portal server 18 and portal database 20 are utilized by vendor administrator 12 to facilitate the provision of educational and promotional event programs to customer s 16 through a partner 14.

Vendor administrator 12 is a company (e.g. IBM, Oracle, TD Waterhouse, CIBC, etc.) that sells products or services (e.g. software programs, financial services, internal training, etc.) to end user customer s 16 or employees through an internal or external partner 14. Vendor administrator 12 can improve the penetration of its products or services into the marketplace by helping partner 14 put on educational and promotional events for customer s 16. It is contemplated that the event would be associated with the vendor administrator's 12 products or services (e.g. software programs, financial services, internal training, etc.) that the partner 14 is selling to customer s 16.

partner 14 can either be a conventional reseller and distributor (e.g. Compugen, Ingram Micro, Union Securities, AIM Mutual Funds, etc.) of the products or services of vendor administrator 12 or it can be any member of the vendor's 12 external network (e.g. partnerships, alliances, agents, resellers, etc.) or internal network (division, business units, departments, groups, employees). It should be understood that partner 14 could also be the same entity as the vendor administrator 12.

Customer16 is an end purchaser/consumer such as a business entity (e.g. Province of Ontario, Petro Canada, Scotia Bank, etc.) or an individual end user. Event management system 10 allows partner 14 to provide a customer 16 with an invitation to participate in an event program over communications network 15. It should be understood that customer 16 when first invited is a prospective attendee. When customer 16 accepts the invitation, customer 16 becomes a confirmed registrant. Finally, when customer 16 attends event program, customer 16 becomes an attending registrant.

Portal server 18 and portal database 20 are utilized by vendor administrator 12 to facilitate the provision of educational and promotional event programs to customer s 16 through a partner 14. Portal server 18 and portal database 20 include any software, hardware and/or device capable of facilitating access to the features of event management system 10. It is preferred that the computer software and hardware utilized within event management system 10 are suitable to provide a website or other Internet-based graphical user interface accessible by users. For example, portal server 18 and database 20 can be implemented using a Dell PowerEdge 2560 2.4 GHz/512K Cache Xeon (221-0230) system running Windows Server 2003.

The portal data within portal database 20 is stored as a relational database. The portal data is stored in numerous tables with defined relationships between those tables. The data tables contain data concerning product groups, events and direct mail campaigns scheduled by users of event management system 10 and other information (e.g. system user information, address details, province codes etc.) Additionally, portal database 20 has views and stored procedures defined to facilitate easy access and updating of the database. While portal database 20 is implemented in Microsoft's SQL Server 2000, it could be implemented in any relational database. While portal database 20 is shown as being distinct from vendor administrator 12, it should be understood that various combinations of distributed databases could be utilized within event management system 10. Also, it should be understood that portal database 20 can be any type of database, such as a hierarchical, object oriented, relational type database.

Communication between vendor administrator 12, partner 14, customer 16 and portal server 18 is achieved through the use of communications network 15 which can be any suitable communication means (e.g. Internet, Intranet, telephone network, wireless network, etc.) It is contemplated that secure communications within event management system 10 could be provided to ensure that potentially confidential information is not provided to undesirable third parties. Specifically, portal server 18 and portal database 20 can be implemented to include various standard security features including encryption, compression, firewalls, etc.

Portal server 18 provides vendor administrator 12, partner 14, and customer 16 with their own particular interface. Specifically, vendor administrator 12 is provided with a vendor interface on portal server 18 where a vendor administrator 12 can set-up an event offering within event management system 10. partner 14 is provided with a partner interface on portal server 18 where partner 14 can go to initiate an event program and where partners 14 can gain access to a repository of event program specific information as will be described. Finally, customer s 16 are provided with their own customer interface on portal server 18 where invited customer s go to register to attend a particular event program being hosted by a partner 14.

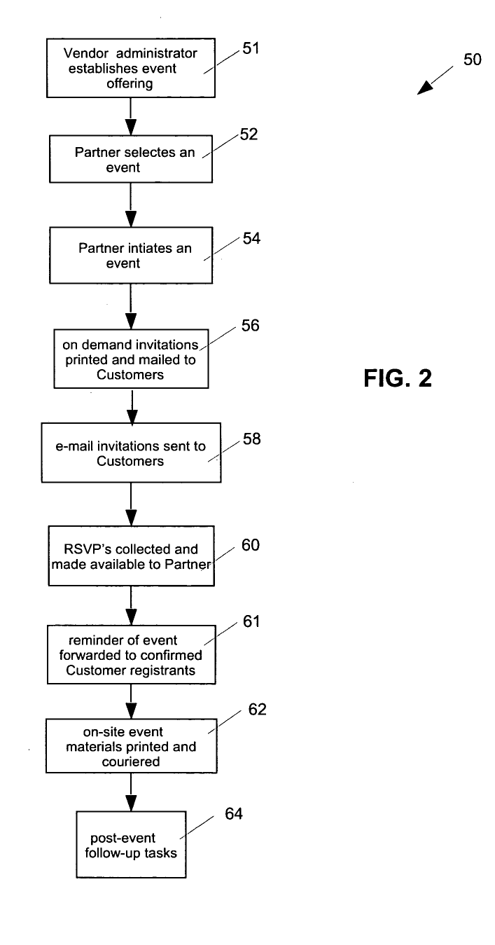

Referring now to FIGS. 1 and 2, the general operational steps 50 of event management system 10 are illustrated. At step (51), vendor administrator 12 logs into the vendor interface of portal server 18 and activates an event program on portal server 18. At step (52), partner 14 logs into the partner interface of portal server 18 and selects an event program that is listed on portal server 18. It should be understood that vendor administrator 12 may set up a number of event programs within portal server 18. At step (54), partner 14 initiates an event program.

At step (56), invitations are printed and mailed to customer s 16. In addition, when a customer 16 receives an invitation and registers on portal server 18, they are able to indicate that a colleague should be invited as well as will be described in detail. When this occurs, at step (58), if approved by partner 14, e-mail invitations are also sent to invited colleagues.

At step (60) RSVP's in the form of Website registrations by invited customer s 16 are collected and the information provided to partner 14 so that partner 14 can monitor registration to ensure sufficient customer s are registered and/or to decide whether to go ahead with event etc. At step (61), reminder e-mails are sent to customer s 16 prior to the event date. At step (62) portal sever 18 forwards event materials to a real world printing facility (e.g. The Printing House) that is physically closest to the partner's 14 event location and on-site event materials are printed and couriered to the registered company location provided by partner 14. Finally, at step (64), post-event follow up activities are conducted. Specifically, “thank you” e-mails are sent out to partner 14 and customer 16, evaluation questionnaires are completed by partner 14 and customer 16, final attendance and data intelligence reports are made available to vendor administrator 12 and partner 14.

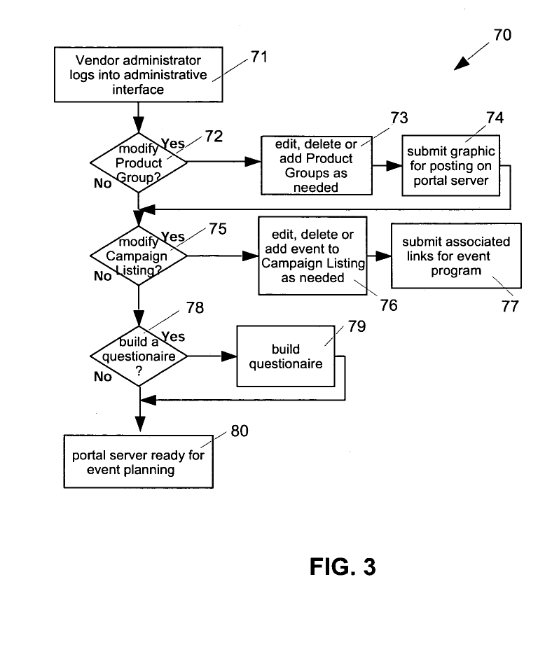

Referring now to FIGS. 1, 2, 3 and 4A, 4B, 4C, 4D, 4E and 4F, the vendor administrator interface of the event management system 10 utilized by vendor administrator 12 will now be described. Specifically, FIG. 3 illustrates the processing steps 70 associated with the VENDOR ADMINISTRATIVE SETUP routine of event management system 10. As previously discussed, the various interfaces that are used to manage the day-to-day use of event management system 10 are secure and password protected. Portal server 18 only allows vendor administrator 12 to have access to the administrator interface of portal server 18. The administrator interface allows vendor administrator 12 to add, review, modify and activate events on portal server 18.

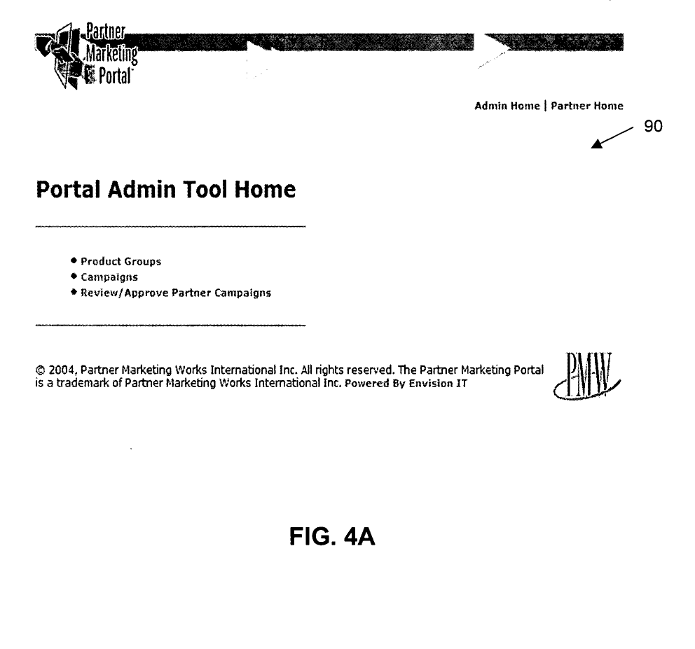

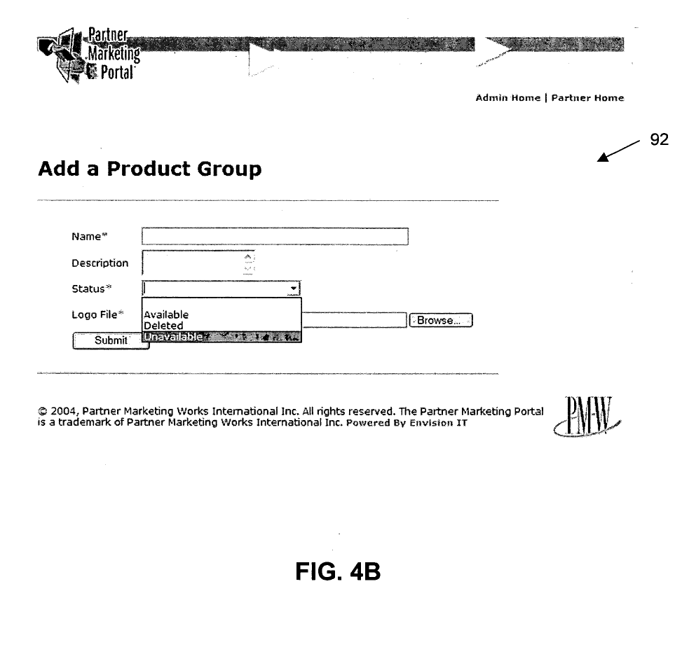

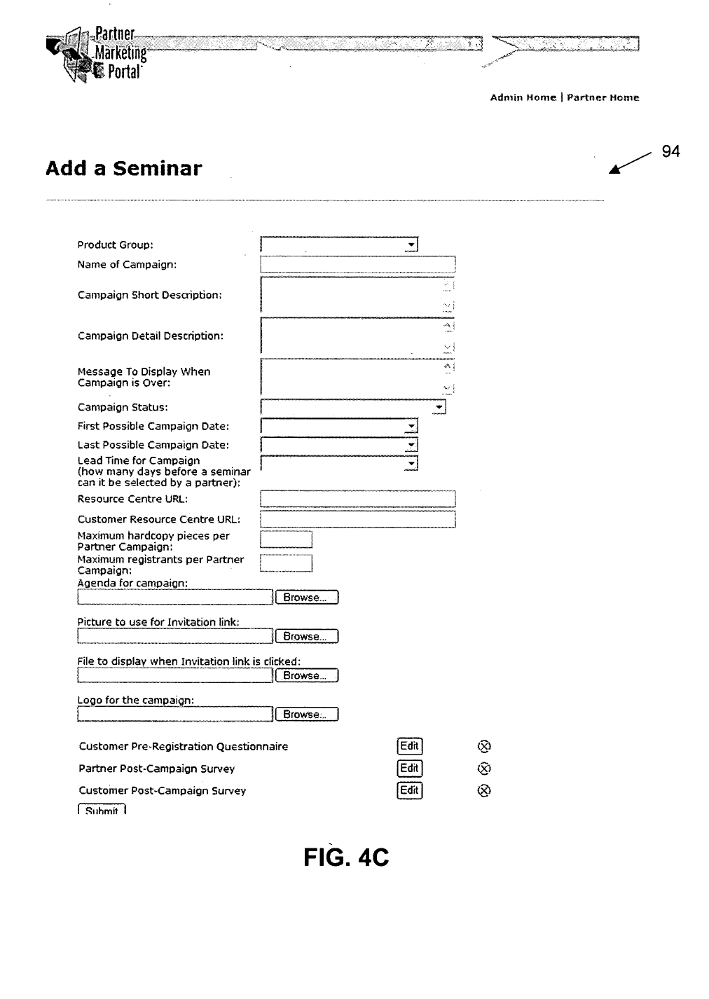

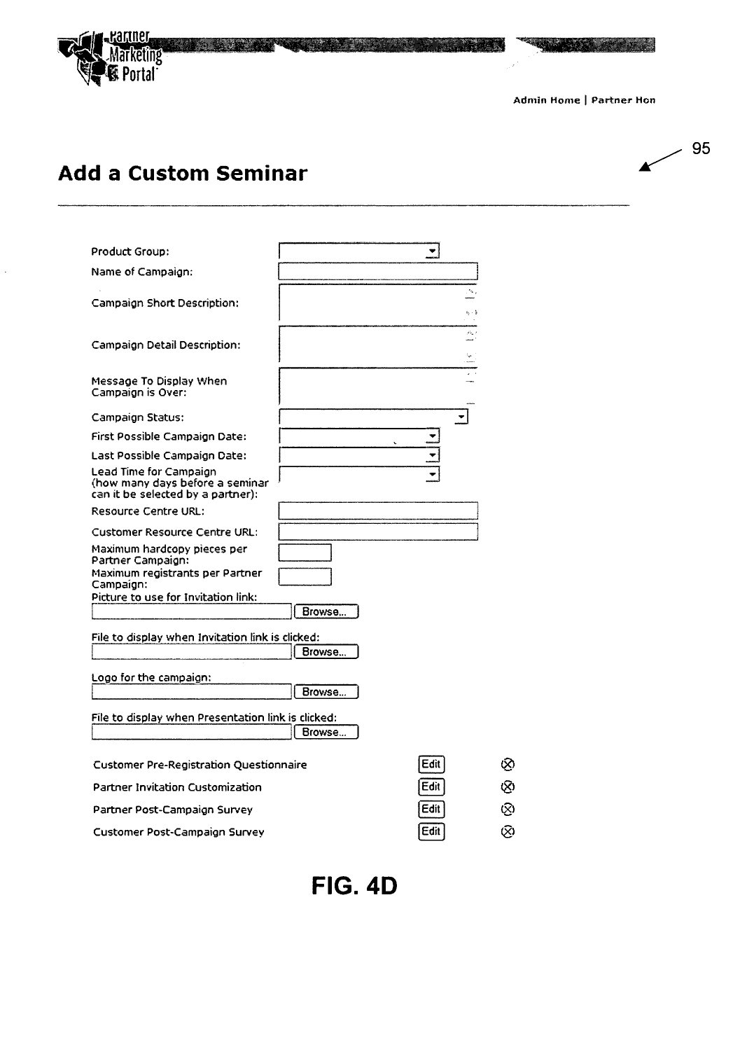

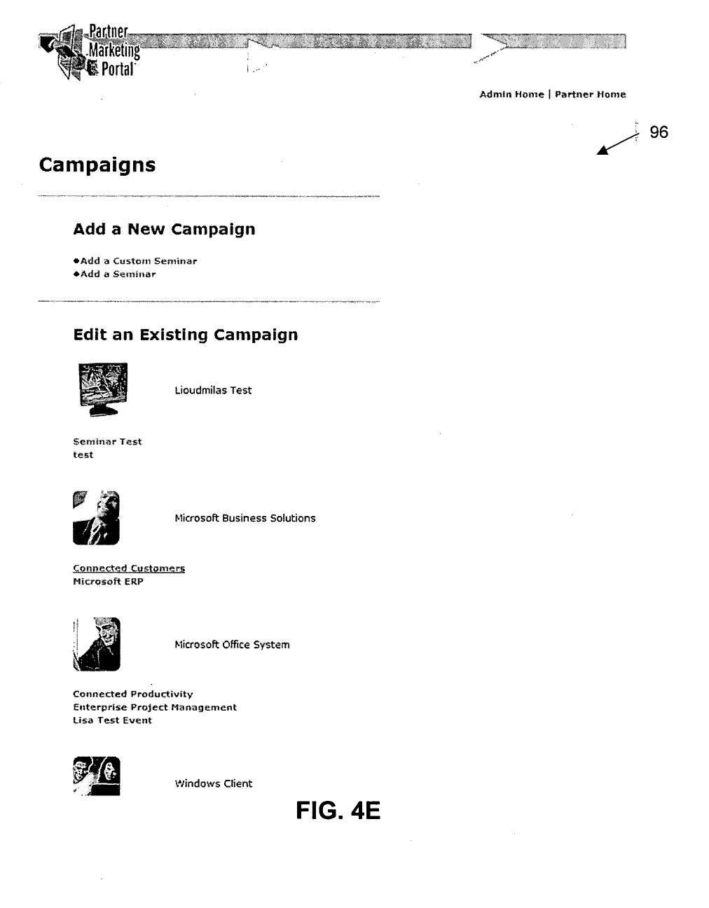

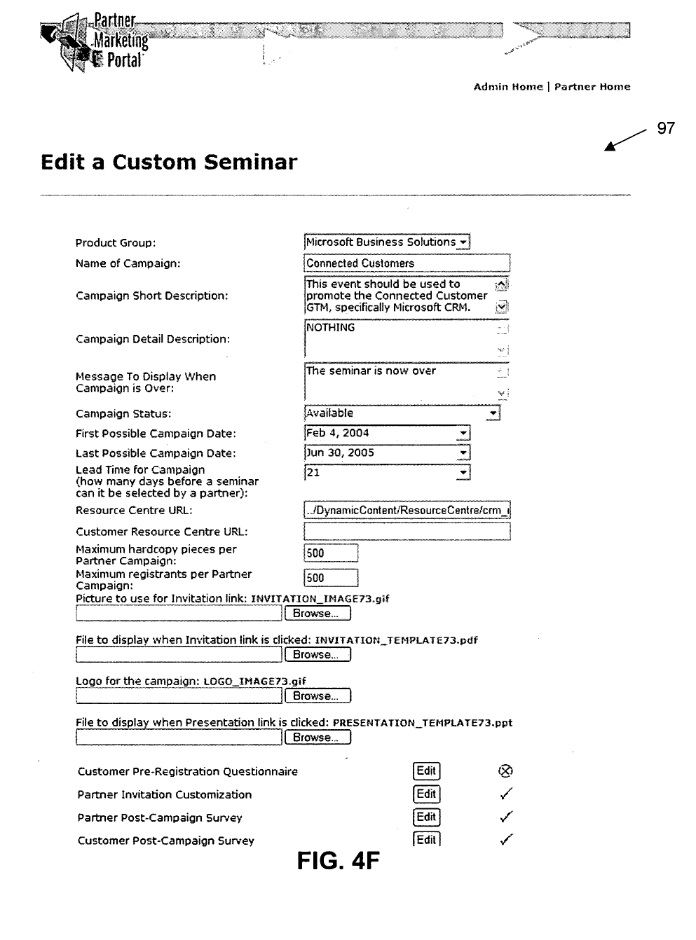

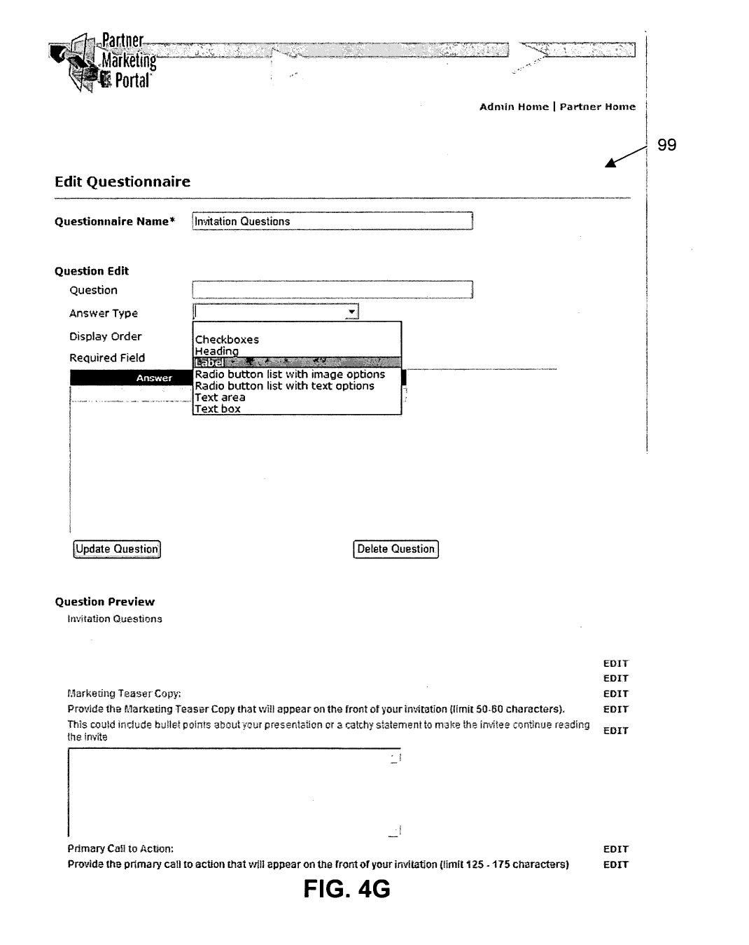

Specifically, at step (71), vendor administrator 12 logs into the vendor administrative interface of event management system 10 and is provided with the “Portal Admin Tool Home Page” screen 90 (FIG. 4A). As can be seen at the top of the “Portal Admin Tool Home Page” screen 90, a Product Groups section is provided which allows vendor administrator 12 to review, modify and add the Product Groups listing. Product Groups represent a particular group of vendor products or services that are being sold to customer 16 through partner 14. Also at the top of the “Portal Admin Tool Home Page” screen 90 is the Campaign listing access, vendor administrator 12 is provided with the ability to review, modify, and add a new event program. The third option presented to the Vendor Adminstrator at the top of the “Portal Admin Tool Home Page” is a link to review, approve and delete current partner event. This page also allows the Administrator to edit some of the event specific information for each event (e.g. Change the Date; Change the location; Change the Event Name)

At step (72), it is determined whether vendor administrator 12 wishes to modify the Product Group. If so, then at step (73), vendor administrator 12 will edit, delete or add Product Groups as needed. Specifically, if vendor administrator 12 wishes to add a Product Group, vendor administrator 12 will select the “Product Group” link on the “Portal Admin Tool Home Page” screen 90. As shown in FIG. 4B, vendor administrator 12 will then be presented with a “Add a Product Group” screen 92 that contains input fields into which vendor administrator 12 can type in the name of the Product Group (e.g. “Software Assurance”).

Vendor administrator 12 then selects the desired status, namely whether AVAILABLE or DELETED. By selecting AVAILABLE, the vendor administrator 12 ensures that the Product Group typed above will become an active Product Group in the portal. Vendor administrator 12 would choose AVAILABLE if they were adding a new Product Group to the listing. By selecting DELETED, the vendor administrator 12 ensures that the Product Group (and all available events for this Product Group) are no longer available for partner 14 to view on portal server 18. Finally, at step (74), there is an input screen region for a Product Group Logo Filename and File Path that allows vendor administrator 12 to specify the logo or image that will appear throughout the portal for this product group. Finally, vendor administrator clicks “submit” to enter the selected changes to the Product Group listing.

Vendor administrator can also edit an existing Product Group by selecting the Product Group Name link (see FIG. 4A) next to the Product Group to be edited from the “Portal Admin Tool—Product Groups Page” screen 90. The “Edit a Product Group” screen 92 will then appear pre-populated with the existing data and desired changes can be made to the Product Group information listed therein.

At step (75), it is determined whether vendor administrator 12 wishes to modify the Campaign Listing. If so, then at step (76), vendor administrator 12 will edit, delete or add Campaign Listing as needed. Specifically, vendor administrator 12 can define new event programs, add, and edit the Campaign Listing. When vendor administrator 12 defines a new event program and makes it AVAILABLE, the new event program will be made available to partners 14 on the portal server 18. Adding or editing event programs will also affect the selection of programs available to partners 14 on the portal server 18. Specifically, if vendor administrator 12 wishes to add a new event program (e.g. seminar program), vendor administrator 12 will select the “Add a new Seminar” or “Add a new Custom Seminar” link on the “Portal Admin Tool—Campaigns Page” screen 90. As shown in FIG. 4C, and then vendor administrator 12 will then be presented with an “Add a Seminar” or “Add a Custom Seminar” screens 94 (FIG. 4C) that contains input fields into which vendor administrator 12 can type in the name of the new event.

As shown in FIGS. 4C and 4D, the fields presented within the “Add a Seminar” screen 94 (FIG. 4C) and “Add a Custom Seminar” screen 95 (FIG. 4D) require the vendor administrator 12 to link to files necessary to promote the event to partner 14 through partner interface of event management system 10. The fields that can be customized include the event name, the messages to be displayed on portal server 18 in association with the event, and a status. The event name is inserted in numerous areas of the portal, and also used for the reminder and invitation e-mails. Also, an event description is defined by vendor administrator 12 for presentation to partner 14 and customer s 16. Vendor administrator 12 can also define the message to display once the event program has occurred.

As shown in FIGS. 4E and 4F, event management system 10 also provides vendor administrator 12 with the opportunity to edit an event program at step (76). When vendor administrator 12 selects the link that equals the name of the campaign/event from the “Edit an Existing Campaign” screen 90, vendor administrator 12 is presented with the “Edit an Existing Seminar” 96 (FIG. 4E) or “Edit an Existing Custom Seminar” screen 97 (FIG. 4F). Once the name of the campaign to be edited is selected, a pre-populated page with the existing data for that event program is presented on the “Edit an Existing Seminar” or the “Edit an Existing Custom Seminar” screen 98. Vendor administrator 12 then performs the desired changes and clicks submit.

As with the Product Group set up, an event program must be given a status. That is, vendor administrator selects one of the following status settings: AVAILABLE, UNAVAILABLE or DELETED. Vendor administrator 12 defines the first and last possible dates for the event program along with the lead-time required to execute the event. The status AVAILABLE, means that the event description will be posted on portal server 18 and can be accessed by partner 14. The status UNAVAILABLE, means that the message stored within the “Message To Display When Campaign is Over” field will be posted on portal server 18 and can be accessed by partner 14. The status DELETED means that no associated text is posted on portal server 18. The remaining fields require vendor administrator 12 to provide file names that will be called by portal server 18 for various purposes. For example, vendor administrator 12 will provide a file path so that for that seminar program, a partner 14 can locate a Resource Center or so that a partner 14 or customer 16 can access Brochure or Letter samples for a customer mailing.

At step (78), it is determined whether vendor administrator 12 wishes to build a questionnaire (i.e. conduct data gathering). If so, then at step (79), vendor administrator 12 will select the “Edit” button from the associated questionnaire type at the bottom of the Add or Edit Campaign screens 94 and will be presented with the “Edit Questionnaire” screen 99 (FIG. 4G). Vendor administrator 12 is able to set up each event program so that a customized questionnaire is provided to both partner 14 and customer 16 for the purpose of gathering empirical market data. The types of questionnaires include: a pre-event customer 16 registration questionnaire, a post-event partner 14 evaluation questionnaire, and a post-event customer 16 evaluation questionnaire.

The pre-event customer questionnaire is presented to the partner's 14 customer s 16 as they enter their respective interfaces on portal server 18 via the registration URL. The questionnaires are inserted above the ‘register’ button on the customer interface as will be described. The responses gathered from the questionnaire questions are posted to the registration data file and are available for download by the partner 14 as will be described, and can also be reported to the vendor administrator 12. The post-event partner and customer evaluation questionnaires are accessed using a follow-up e-mail generated by event management system 10 on or after the event has occurred. The questionnaires are set-up by the vendor administrator 12 when the event program is first created. Before finalizing the event setup, vendor administrator uses the Edit buttons to the right of each designated questionnaire box (FIG. 4F). Vendor administrator 12 assigns a name to each questionnaire. Using a drop down selection box, questions are programmed to capture responses using radio buttons for single choice responses, check boxes for multiple responses and text boxes for free form answers to open-ended questions (FIG. 4F). If the radio button or check box answer types are chosen, then vendor administrator 12 defines the possible answers that will be displayed.

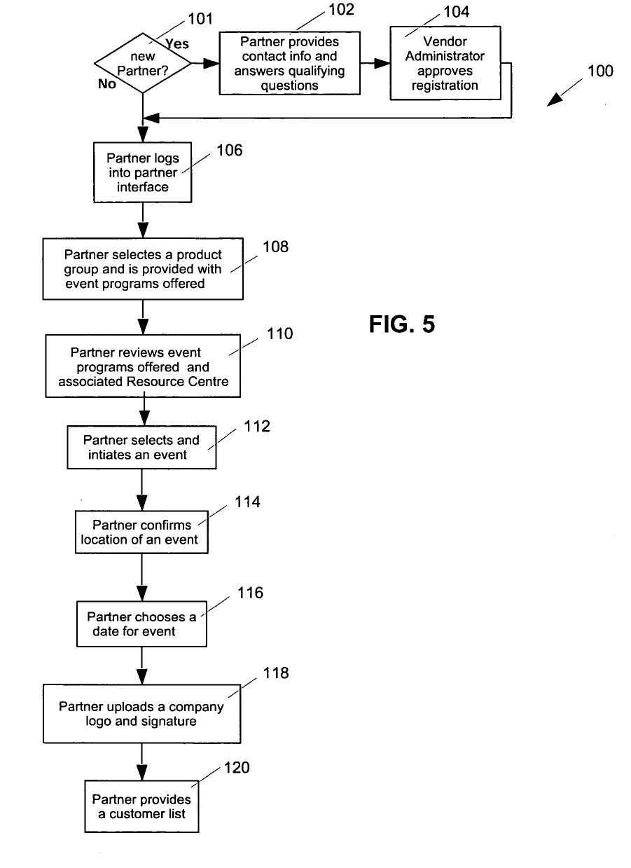

Referring now to FIGS. 1, 2, 5 and 6A, 6B, 6C, 6D, the partner interface of the event management system 10 utilized by partner 14 will now be described. Specifically, FIG. 5 illustrates the processing steps 100 associated with the PARTNER SETUP routine of event management system 10. The partner interface allows partner 14 to review, modify and activate events on portal server 18.

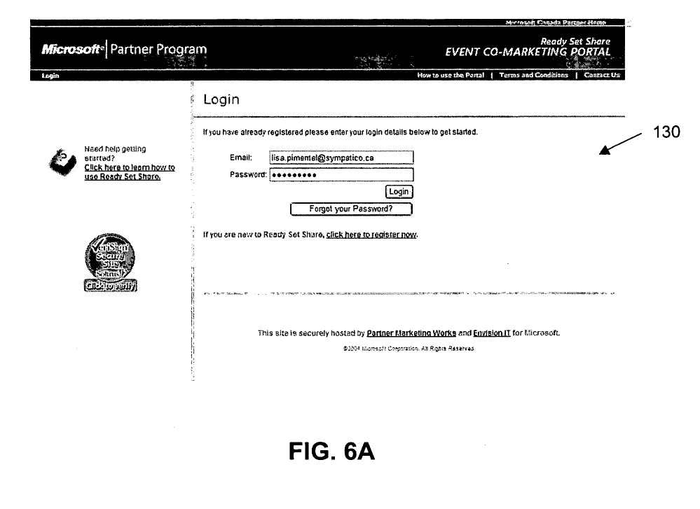

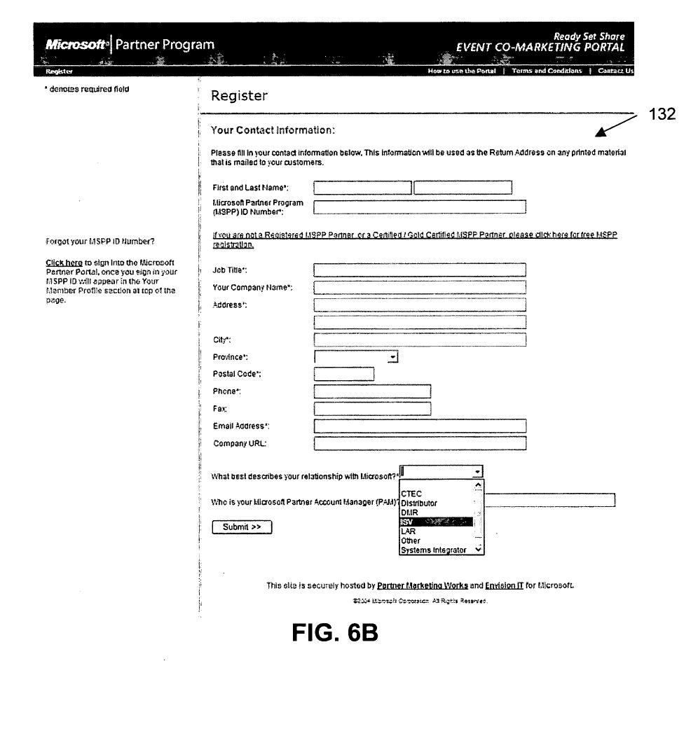

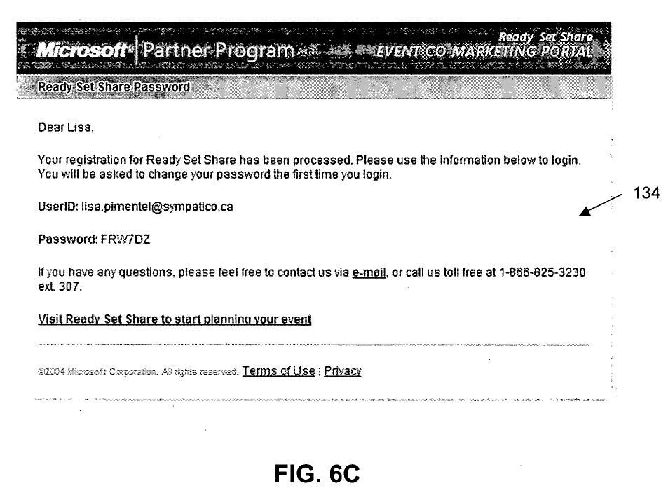

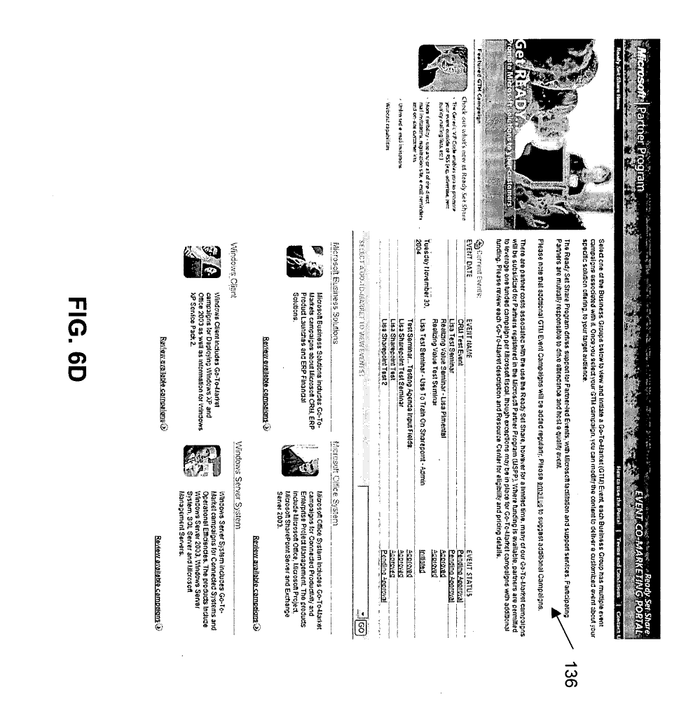

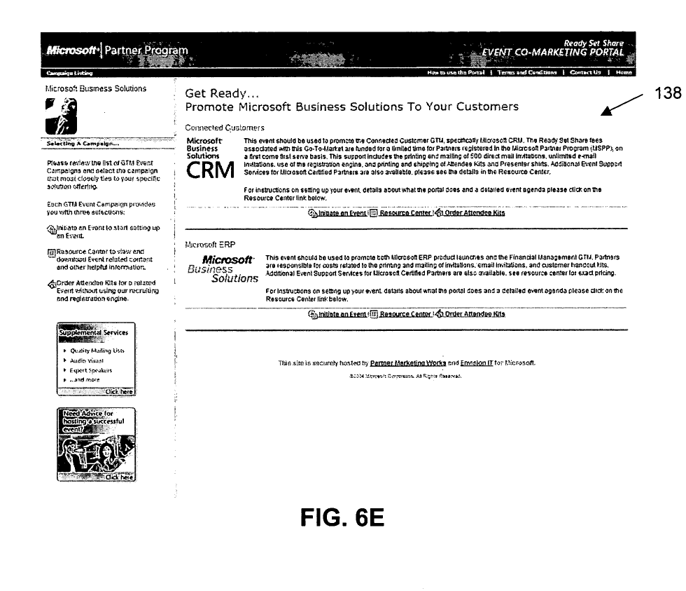

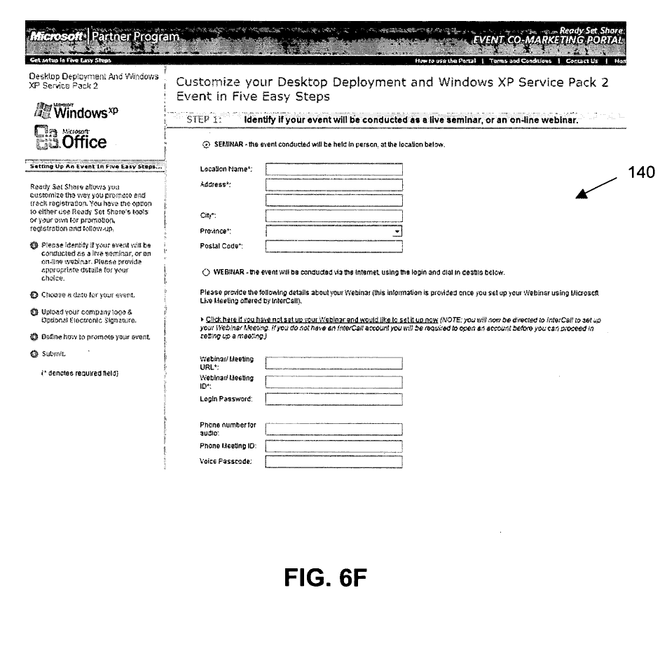

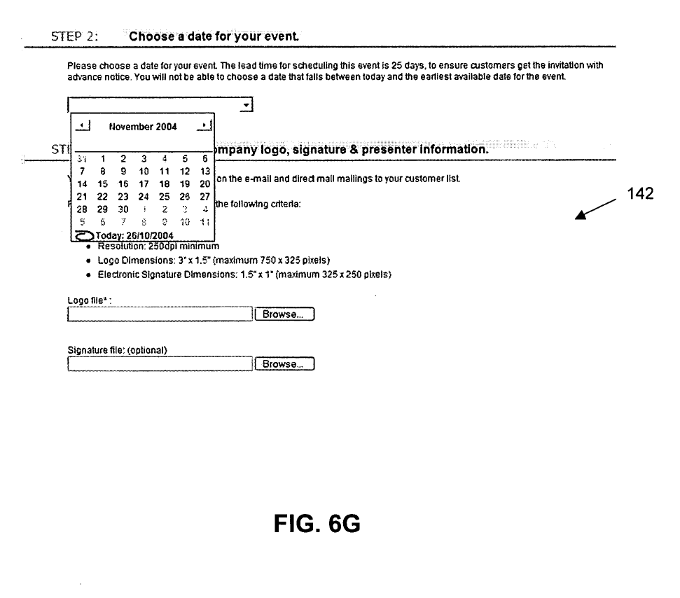

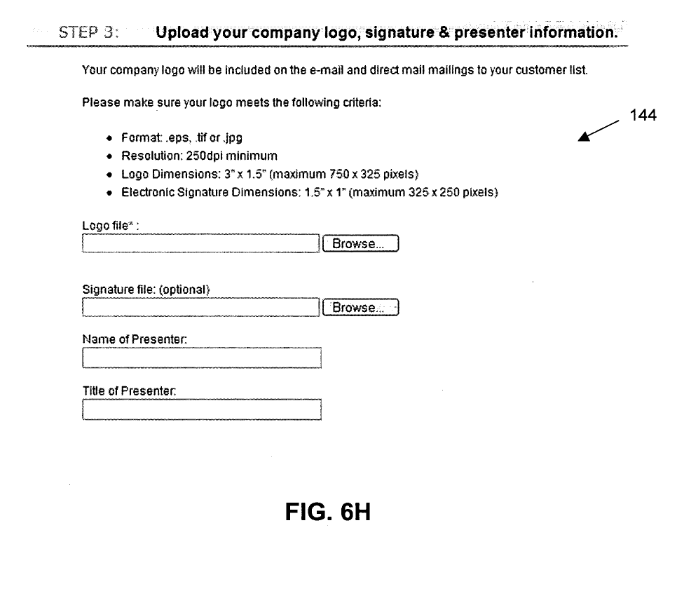

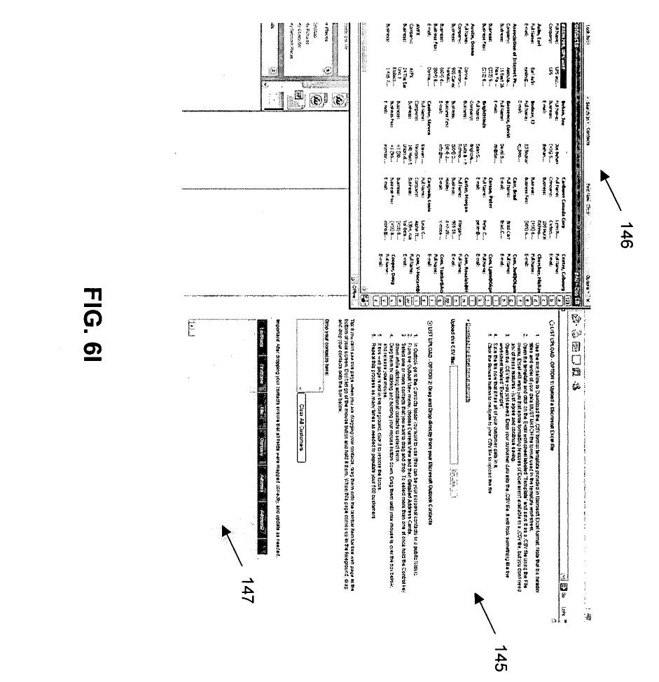

Specifically, partner 14 first logs onto the partner interface of event management system 10 by entering an e-mail address and password at the “Login” screen 130 (FIG. 6A). If at step (101), it is determined that it is the partner's 14 first time at the portal, partner 14 clicks on the “Register Now” link on the “Login” screen 130. At step (102), partner 14 is then presented with the “Contact Information” screen 132 (FIG. 6B) and asked to provide their contact information and answer qualifying questions such as the one in the example below (e.g. “What best describes your relationship with Microsoft”). The user completes the required information and submits it to the event management system 10. At step (104), vendor administrator 12 has the option of viewing the qualification criteria of the partner 14 and allowing or declining registration of the partner 14. After registration is submitted, partner 14 is presented with the “Registration Processing” screen 134 (FIG. 6C) and advised that they will receive an e-mail providing them with their password and login details via e-mail. Event management system 10 randomly generates a password as well as the e-mail to the user with their password and login details as shown in the “Registration Processing” screen 134 (FIG. 6C). At step (106), partner 14 logs into event management system 10. It should be understood that the password provided to partner 14 can be tied to certain portal offerings. For example, it is possible for one class of partner 14 to have access to all portal offerings while a different class of partner 14 is only given access to limited offerings on event management system 10.

After login, at step (108), partner 14 views the product groups available and selects a desired product group. At step (110), partner 14 reviews the “Campaign Listing” screen 136 (FIG. 6D) and considers the posted event topics and their related descriptions to determine which event(s) they would like to initiate (i.e. offer to their customer s 16). As shown in the “Promote Products” screen 136 of FIG. 6D, the vendor administrator 12 (Microsoft) sorts their events by product group. Vendor administrator 12 is provided with “Seminar Options” screen 138 (FIG. 6E) that lists the various seminar options that fall under the product group. Under each seminar description, partner 14 can choose to initiate a seminar and/or visit the “Resource Centre” where they have access to a repository of information related to the seminar subject matter. They can also use the Order Attendee Kits to send an e-mail request for seminar materials to the Vendor Administrator.

The Resource Centre can provide partner 14 with useful resources including links to information on the subject topic, downloads (e.g. slide presentation, white paper, videos), partner co-marketing programs, print and electronic (banner) advertising creative materials (e.g. in pdf format, etc.). It should be understood that these resources are merely limited by what the vendor administrator 12 wishes to provide partners 14 with. The Resource Centre is also accessible from the “View Seminar Details” screen associated with the “Promote Products” screen 136 which is visible to the partner 14 following the successful initiation of a given seminar topic, as will be described later.

If partner 14 is ready to initiate an event (i.e. make a seminar available for customer s 16) then at step (112) they select the “Initiate a Seminar” link on the “Campaign Listings” screen 136.

At the time that the Vendor Administrator adds new Campaigns to the portal offerings, a determination is made whether that particular event will allow the partner to provide customized content to populate the direct mail, or if the partner will have to use the Standard pre-determined content provided by the vendor to market the event.

If the event is programmed to be ‘customizable’, partners are required to provide the content and other information that the Vendor needs to approve before the event can be scheduled. The information includes: the Presentation file that will be used at the event; the content for the direct mail invitation/ or a sample of the invitation the partner wishes to use; the Agenda for the event. The partner also chooses to use the CustomerRegistration system of the event management system, or can insert a different registration method for their Customers. The partner can also choose to utilize the automated e-mail services of the portal, or turn e-mail off.

Once the event is fully defined, the content is submitted to the Vendor Administrator for review and/or approval. Customized events between vendor administrator 12 and partner 14 are be executed by utilizing SharePoint technology as a vehicle to communicate and customize template presentations and/or direct mail brochures/invitations. An (electronic) approval process is used to ensure mutual satisfaction between vendor administrator 12 and partner 14 prior to the final presentation and/or direct mail/invitation options go live on the portal.

Once the customized content is approved, the partner is notified via e-mail that they can now go back to the Portal to continue setting up the event.

At this time(114), they are asked to complete the following five step process:

Step 1: Identify if the event will be conducted as a live seminar, or an on-line Webinar

Step 2: Choose a Date

Step 3: Upload a Company Logo. Signature, and the presenter name

Step 4: Provide a CustomerList

Step 5: Submit initiation form The “Five Step” screen shown as 140, 142, and 144 (FIG. 6F, 6G, 6H and 6I) first at step (114) asks partner 14 to confirm their event details (under the Step 1 banner in FIG. 6F). The seminar location or Webinar details is manually provided by the partner (under Step 1 banner in FIG. 6F). Then partner 14 at step (116) is asked to select a date for their event using a pop-up calendar screen 142 (under the Step 2 banner in FIG. 6G). The calendar screen utility utilized is manufactured by PCC Limited of Mississauga, Ontario, Canada.

At step (118), partner 14 is presented with the third step (under the Step 3 banner in FIG. 6H) and asked to upload their company logo and company representative's signature in an electronic format as well as the actual name and title representing the person whose signature is being used. A pdf of the invitation letter and brochure are provided indicating where the areas of partner and customer customization are located. At step (120), partner 14 is asked to provide their customer mailing list to event management system 10. Partner 14 can upload a formatted comma separated values (.csv) file or utilize the conventionally known “drag and drop” feature associated with the Outlook program 146 to transfer the particulars of individuals in their Outlook contact list into the invitation list fields 147 provided on the partner interface 145 (FIG. 6I) of event management system 10. Drag and drop capabilities or data file uploads can be designed for most contact management programs (e.g. Maximizer manufactured by Maximizer Software Inc. of Vancouver, BC, ACT manufactured by Best Software, Inc. of Scottsdale, Ariz., Goldmine Business Contact Manager manufactured by FrontRange Solutions of Colorado Springs, Colo., etc.) Alternatively, partner 14 can enter contact particulars manually.

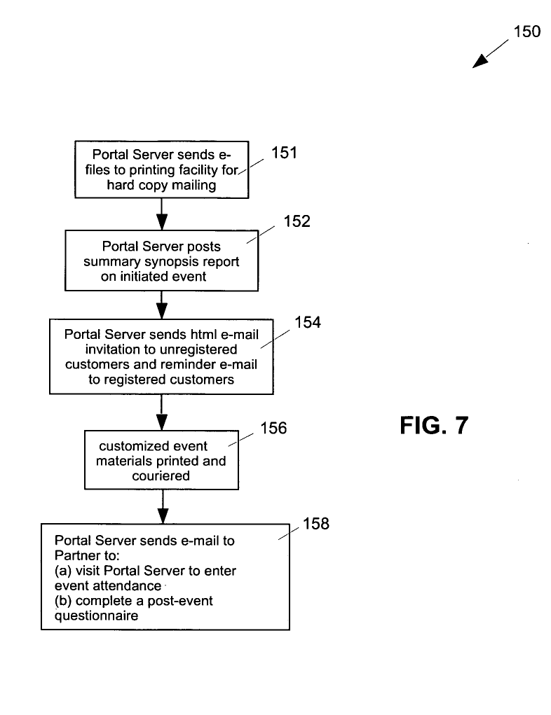

Referring now to FIGS. 1, 2, 7 and 8A, 8B, 8C, 8D, the operation of portal server 18 after an event program has been initiated by partner 14 will be discussed. Specifically, FIG. 7 illustrates the processing steps 150 associated with the EVENT MANAGEMENT routine of event management system 10 carried out by portal server 18. Once an event is initiated by partner 14, portal sever 18 automates a number of event management tasks as will be shown.

Specifically, at step (151), portal server 18 sends the electronic files that were submitted earlier by partner 14 through partner interface to a designated production manager 14. The production manager reviews the files for quality assurance, and then sends the required files to a printing facility (eg. The Printing House) who then prints customized (i.e. using the uploaded partner logo, signature and contact information) and personalized (i.e. using uploaded customer contact information) event invitations and mails them out preferably by first class mail within 48 hours. While event invitations are first sent to customer s 16 by mail only, it should be understood that initial mail and/or e-mail invitations could also be sent by portal server 18.

A Generic VIP Code is assigned to each event that is initated. This identifies the partner and the specifics of their event when the invitee registers to attend using the CustomerRegistration Site. The Generic VIP Code is provided to the partner for the purpose of promoting their event outside of Ready Set Share. For example; the partner can rent mailing and email lists and send out invitations incorporating the Generic VIP Code and registration site URL (quality list owners will only provide their lists to a bonded mail house or printer) or they can advertise their event. This allows the partner with maximum flexibility to promote their event to new prospects.

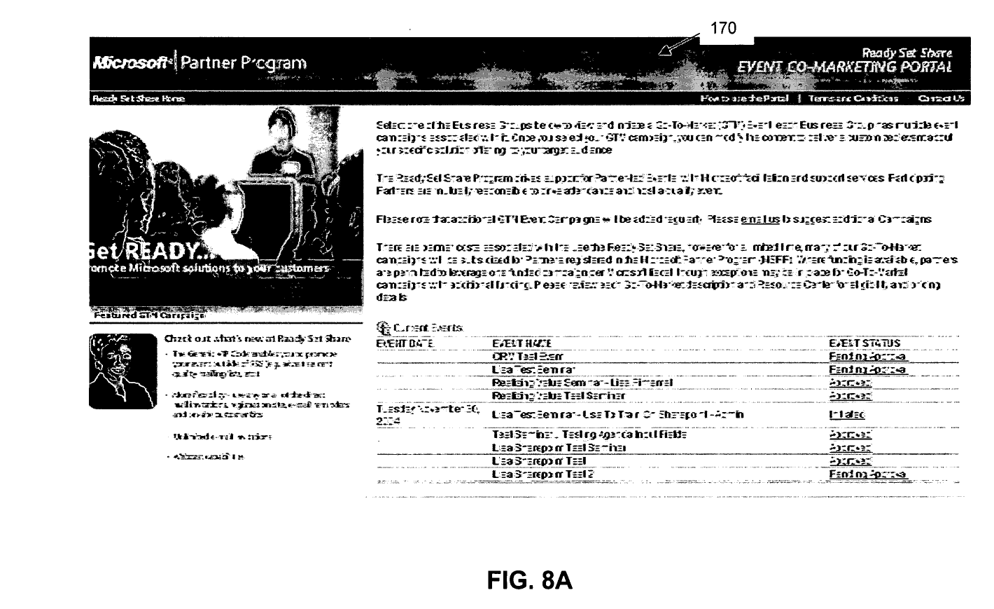

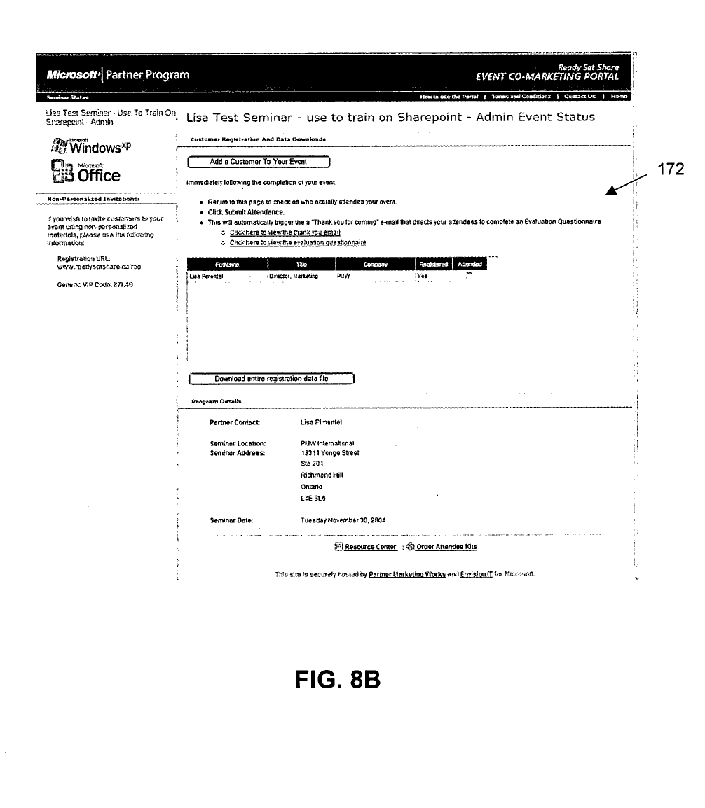

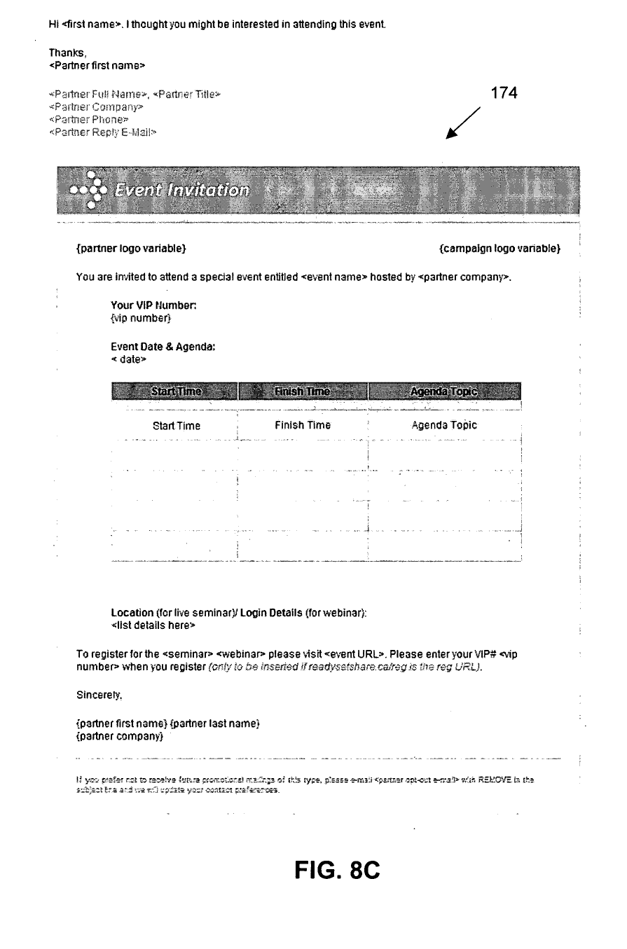

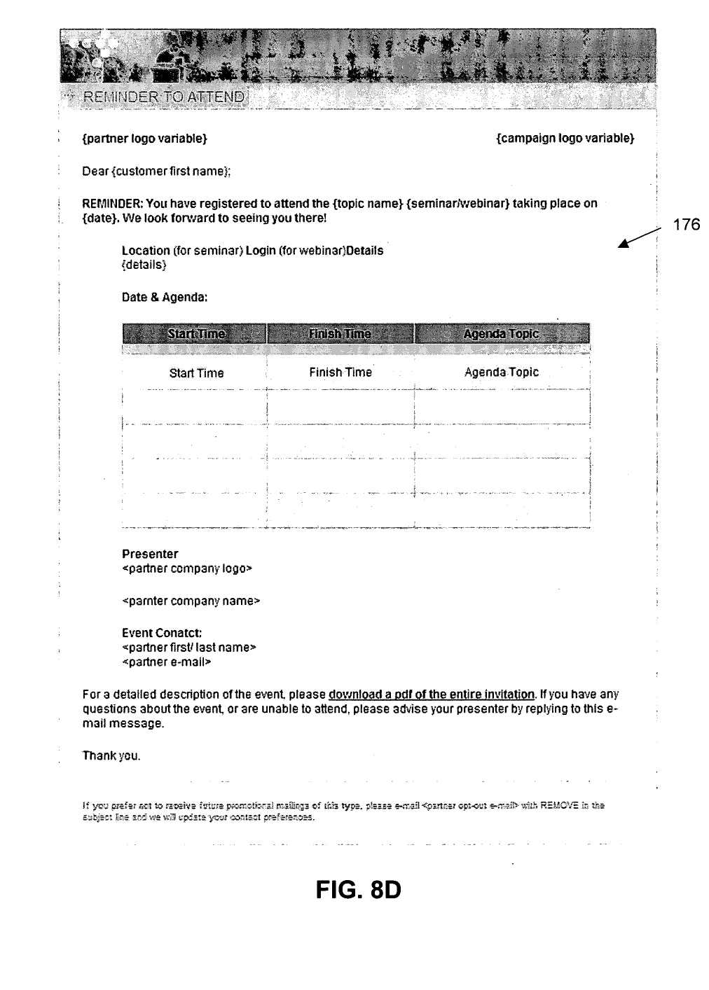

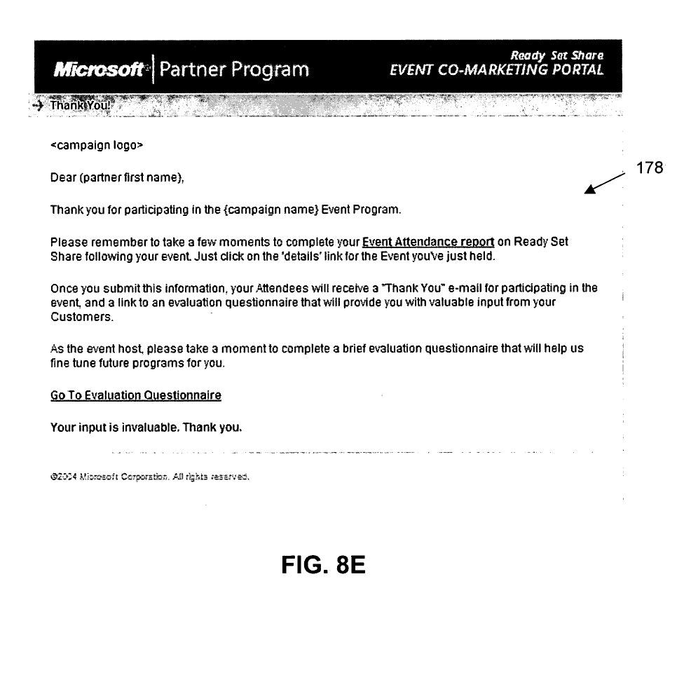

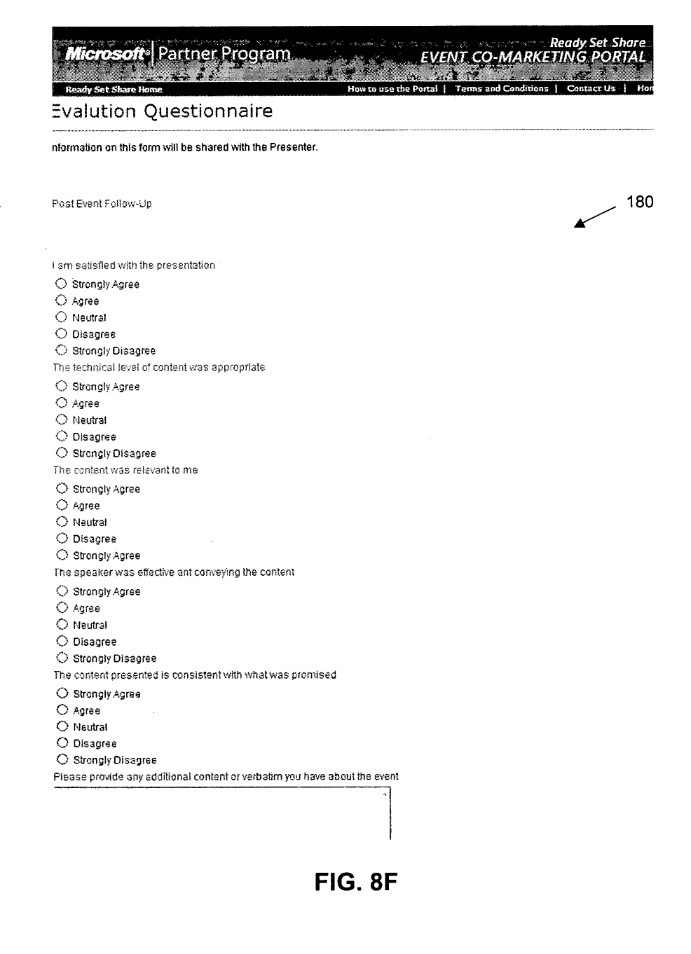

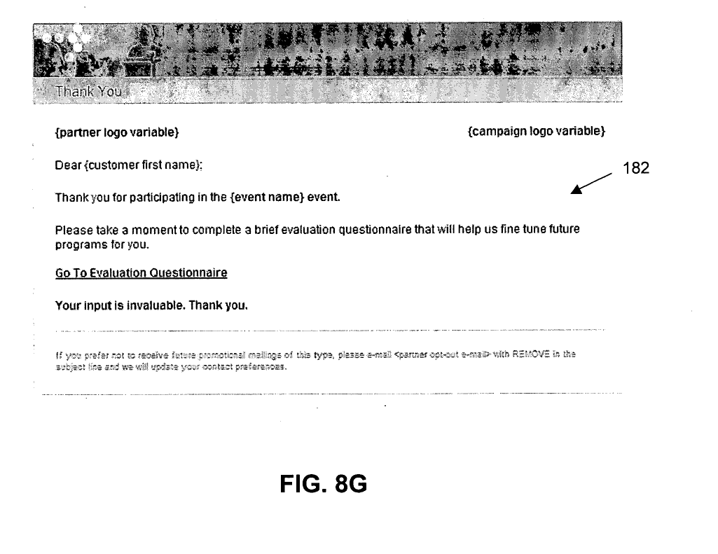

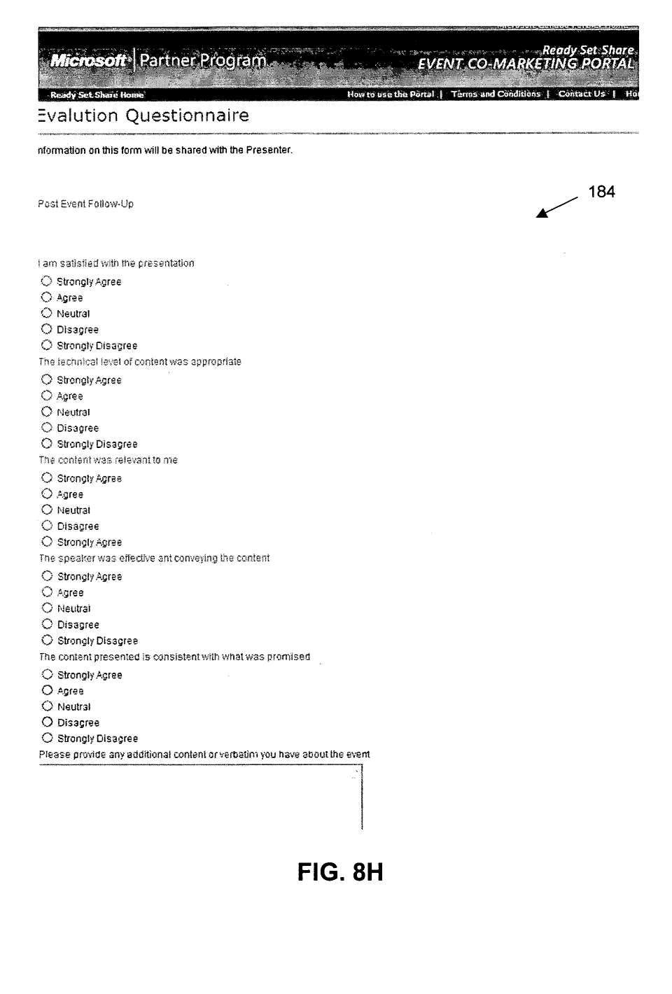

At step (152), portal server 18 compiles a short summary synopsis report concerning the event initiated by partner 14 and posts it on the partner interface screen 170 (FIG. 8A). This posted synopsis report provides partner 14 with basic information concerning the event(s) they have initiated the next time they enter portal server 18 through partner interface. As shown in FIG. 8A, each active event summary provides an “initiated” link that allows partners 14 to view their invitation list on the “Event Status” screen 172, visit the Resource Centre, invite additional customer s 16 and see which invited customer s 16 have registered to attend the planned event program to date (FIG. 8B).

Two weeks prior to the partner 14 event date, at step (154), portal server 18 sends an html e-mail reminder to register invitation 174 (FIG. 8C) to customer s 16 who have not yet registered for the partner 14 initiated event. Three days prior to the partner 14 event, portal server 18 sends another html e- mail reminder/confirmation 176 (FIG. 8D) to the registered customer with the event details. Upon request by the partner, at step (156), the real world printing facility delivers customized and personalized attendee kits and an event poster to the registered company location provided by partner 14. It should be noted that attendee content and poster materials can be customized to the particular event specifications (e.g. hard copy of presentation, white paper, CD-ROM, adhesive badge, poster, etc.)

On the day of the event, at step (158) portal server 18 sends an html e-mail reminder 176 (FIG. 8D) to the partner 14 reminding partner 14 to go to the event's “Event Status” section of portal server 18 to mark attendance by selecting the check box next to each customer name and then submitting all final attendance to portal server 18 for processing. As well, partner 14 is asked to complete and submit an event evaluation questionnaire 180 (FIGS. 8E and 8F) to event management system 10. Finally, customer 19 are sent a follow-up html e-mail 182 (FIG. 8G) asking them to complete and submit an event evaluation questionnaire 184 (FIG. 8H). It should be understood that the above-noted time frames utilized within event management system 10 could be different depending on specific event program requirements at issue.

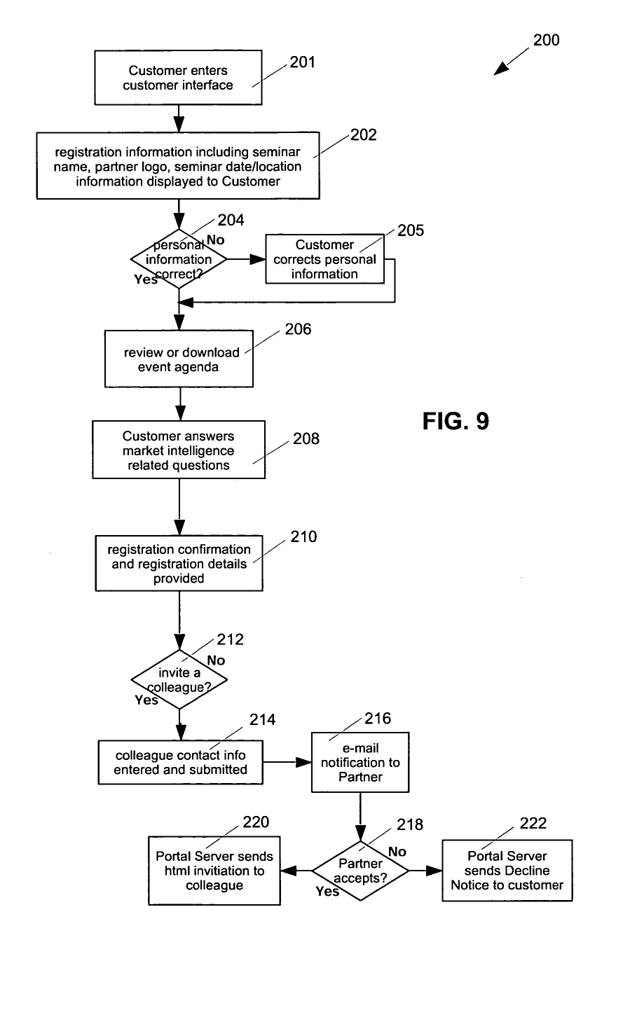

Referring now to FIGS. 1, 2, 9 and 10A, 10B, 10C, 10D, 10E and 10F, the customer interface of the event management system 10 utilized by customer 16 will now be described. Specifically, FIG. 9 illustrates the processing steps 200 associated with the CUSTOMERSETUP routine of event management system 10. The customer interface of event management system 10 allows customer 16 to check their personal contact information (as provided by partner 14) and to review the specified date and location of the planned event. Customer 16 also has an opportunity to download event program agenda and to answer various questions.

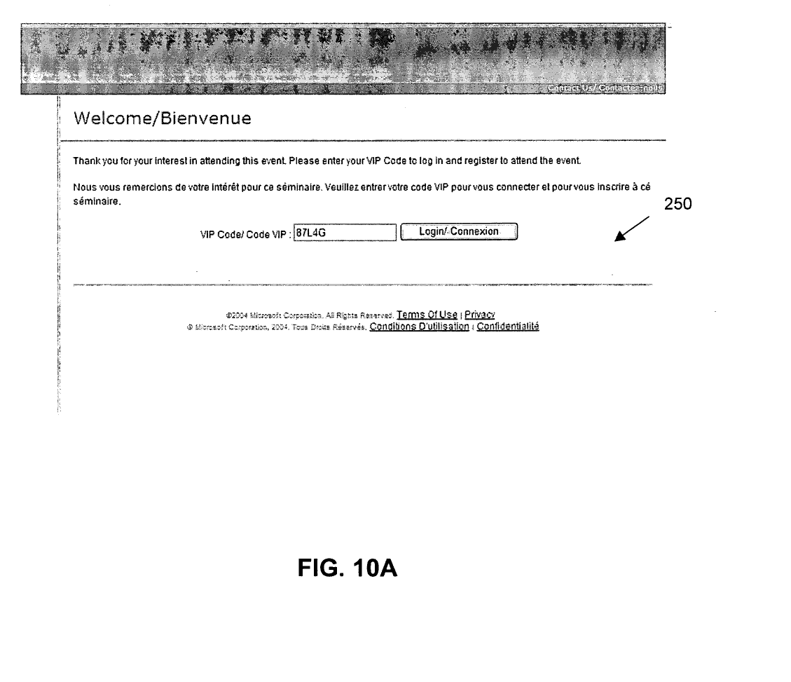

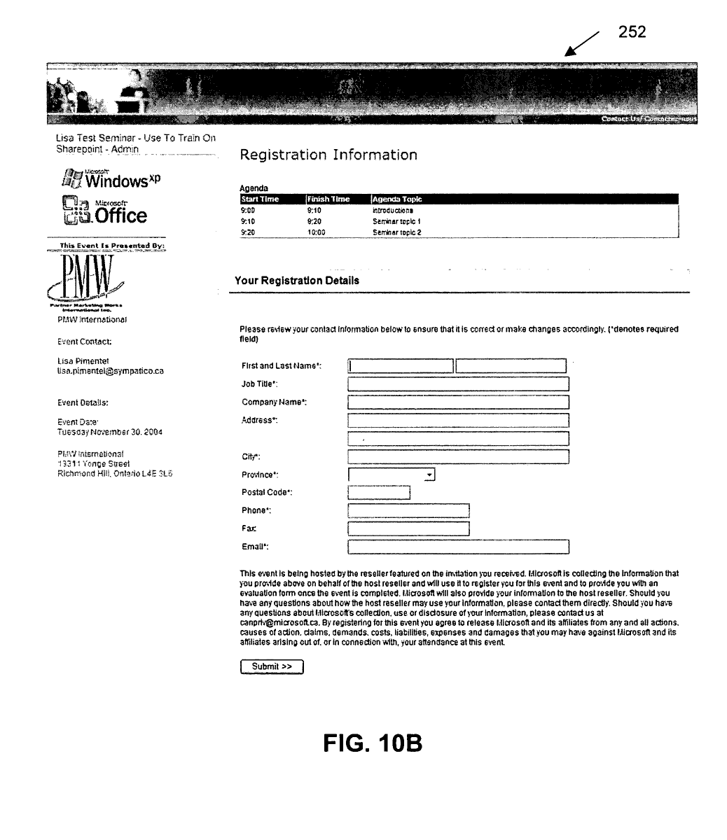

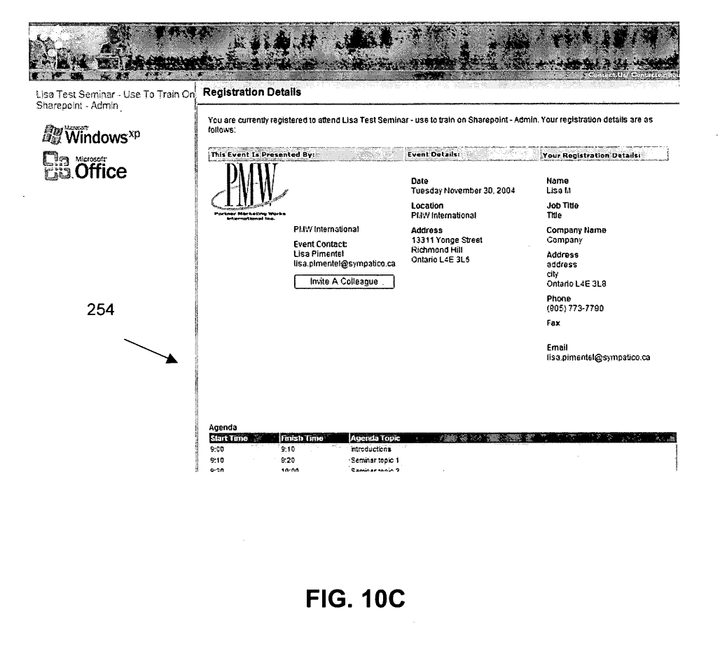

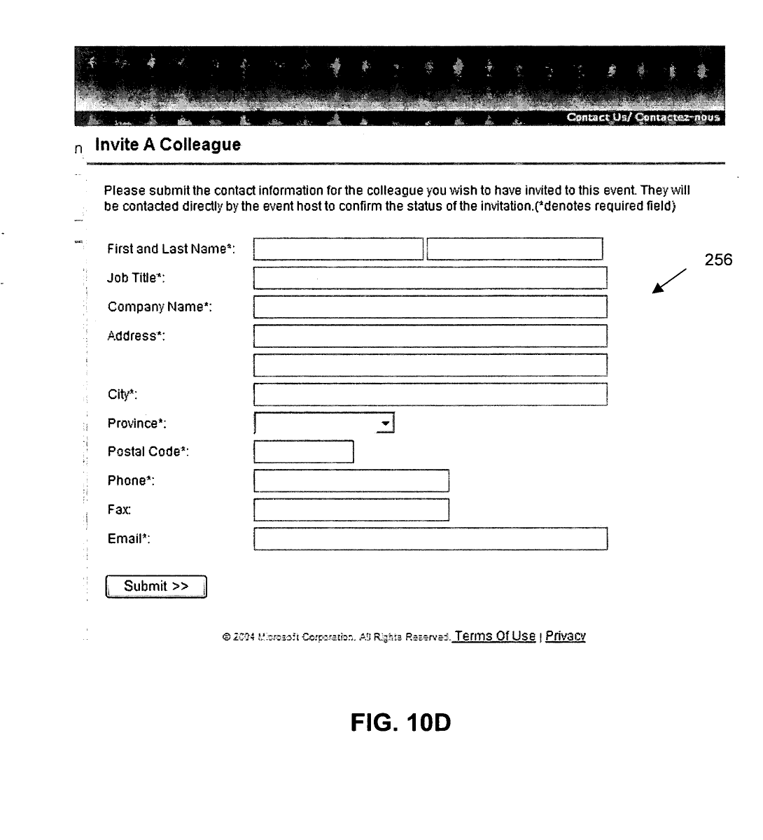

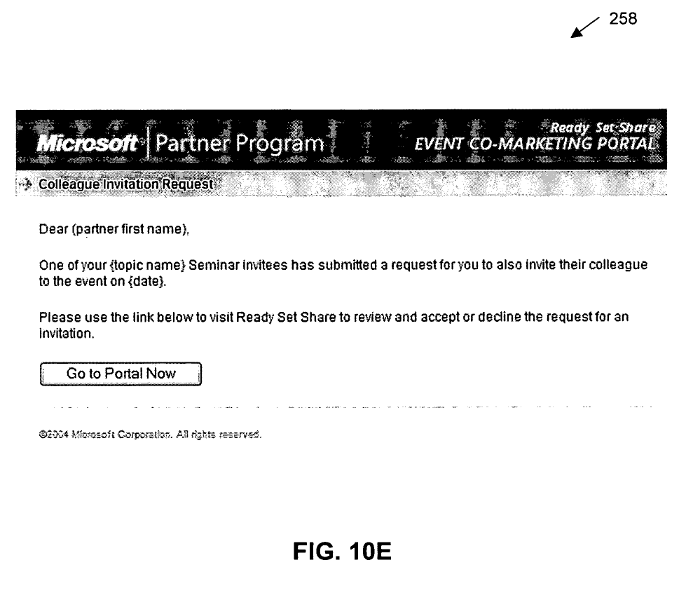

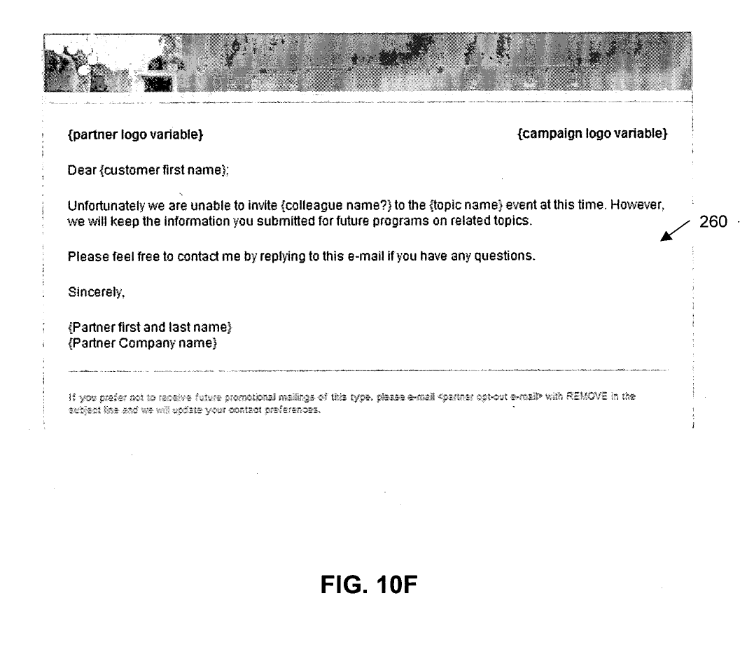

Specifically, at step (201), when the partner's customer 16 arrives at the “Portal Registration” screen 250 (FIG. 10A) they enter their VIP code within the provided field, which is provided on the (hard copy or e-mailed) event invitation they received from portal server 18. Once customer 16 successfully enters the customer interface of event management system 10, at step (202) portal server 18 presents customer 16 at the “Registration Information” screen 252 (FIG. 10B) with various information that partner 14 has provided during event offering setup discussed above. It should be noted that on “Registration Information” screen 252, portal server 18 provides the name of the event, displays the partner logo, event location details and pre populates the customer's contact information as provided by the partner.

Specifically, at step (202) customer 16 is provided with their personal contact information as well as the specified date and location of the event. If at step (204), the personal information is not correct or missing, at step (205), customer 16 has the ability to correct or update his/her information. Customeris also provided the opportunity at step (206) to review or download the seminar program agenda. As well, at step (208), customer 16 may be requested to answer various questions as illustrated in the bottom of the “Registration Information” screen 252 (FIG. 10B). Finally, once customer 16 submits their registration to portal server 18, at step (210), a “Registration Details” screen 254 (FIG. 10C) is provided to customer 16 confirming the event details. Portal server 18 notes any changes to the customer contact information that customer 16 has entered and ensures that these corrections are saved to the partner's invited client list. As well, portal server 18 displays the invited customer 16 as registered, provides the data collected at registration to partner interface at “Event Status” screen 172 (FIG. 8B). The data collected can also be made available, if desired by the vendor administrator 12, through the vendor interface.

At step (212), customer 16 is provided with the opportunity to invite a colleague. If customer 16 wishes to do so, customer will click on the “Invite a Colleague” link, which will cause the “Colleague Contact Information” screen 256 (FIG. 10D) to be provided within which customer 16 can provide the colleague contact information. At step (216), the information is sent in an e-mail format to partner 14, namely the Invitation Request message 258 (FIG. 10E). Partner 14 receives the request via e-mail and at step (218) can accept or decline to invite the colleague. If partner 14 accepts the customer's 16 request, then at step (220), portal server 18 sends an html e-mail Invitation 174 (FIG. 8C) to the colleague and adds the colleague contact details to the partner's invitation list in the “Event Status” screen 172 (FIG. 8B). The invited colleague then becomes a customer 16 for purposes of event marketing system 10 and can log into customer interface and view/correct personal contact information and review event details as discussed above. If at step (218), partner 14 declines the invitation (e.g. seminar is full) then at step (222), portal server 18 sends an e-mail to the customer 16 who requested the colleague invitation with a Decline Notice message 260 (FIG. 10F).

It is also contemplated that event management system 10 will also include several other customizable features. For example, portal server 18 can be configured to support multiple languages for international application. Further, as discussed above, the “drag and drop” feature from the Microsoft Outlook e-mailing program can be designed to support many commercially available contact management programs and databases. Data reporting can be designed to link up to any customer relationship management or database program (e.g. Siebel, Oracle, etc.). Currently, data is provided in an Excel or CSV format with individual fields for each piece of data collected. The e-mail engine can design and execute multiple forms of automated executions in addition to the automated executions currently in use. The e-mail engine can deliver static or dynamic pages linked to portal database 20. Finally, all customer print and electronic communications, with the exception of the “CustomerRegistration Login” screen 250 (FIG. 10A), can be customized on behalf of partner 14 (i.e. company name and/or company logo, company contact information and company representative name, title and signature) and personalized for delivery to their customer 16. It is contemplated that various forms of customization and personalization could be utilized.

Accordingly, event management system 10 allows vendor administrator 12 to provide a number of event offerings from which partner 14 can choose to provide to customer s 16. Portal server 18 provides vendor administrator 12 with an efficient method of disseminating event material to end user customer s 16 by practically empowering partners 14 to arrange events for their customer s 16. Since event management system 10 facilitates attendance of customer s 16 at partner hosted events, customer s 16 are better acquainted with the products/services associated with vendor administrator 12 and provided through partner 14. As a result, vendor administrator 12 and partner 14 both realize significant benefits associated with event attendance.

As will be apparent to those skilled in the art, various modifications and adaptations of the structure described above are possible without departing from the present invention, the scope of which is defined in the appended claims.

1. A method of managing an event offering over a communication network, said event offering being directed at a customer by a vendor through a partner, said method comprising:
(a) obtaining an event offering over the communication network from the vendor, said event offering having a plurality of operational characteristics;
(b) obtaining operational characteristics for the event offering from the partner over the communication network;
(c) generating a customized event offering based on the operational characteristics such that the customized seminar offering reflects the partner's identity; and
(d) providing the partner with the ability to manage said customized event over the communication network.

2. The method of claim 1, wherein in (a), said operational characteristics include event date, event location, partner company name, partner logo, partner signature and partner customer list.

3. The method of claim 2, wherein (d) further comprises automatically forwarding invitations to customer s on the partner customer list regarding the event.

4. The method of claim 3, wherein (d) further comprises automatically tracking responses from said customer s to said invitations.

5. The method of claim 3, wherein (d) further comprises adding additional customer s to the customer list.

6. The method of claim 3, wherein (d) further comprises allowing customer s to add additional customer s to the customer list.

7. The method of claim 3, wherein (d) further comprises sending event invitations for printing and delivering to each customer on said partner customer list.

8. The method of claim 1, wherein (d) further comprises obtaining a registered company location from the partner and sending event related materials for printing and delivery to said registered company location.

9. The method of claim 1, further comprising allowing the vendor to provide a questionnaire to the partner regarding the quality of event management.

10. The method of claim 1, further comprising allowing the vendor to provide a questionnaire to the customer regarding the quality of event.

11. An event management system for managing a event offering over a communication network, said event offering being directed at a customer by a vendor through a partner, said system comprising:
(a) a vendor interface module for obtaining an event offering over the communication network from the vendor, said event offering having a plurality of operational characteristics;
(b) a partner interface module for obtaining operational characteristics for the event offering from the partner over the communication network;
(c) a portal server for:
(i) generating a customized event offering based on the operational characteristics such that the customized event offering reflects the partner's identity; and
(ii) providing the partner with the ability to manage said customized event over the communication network.

12. The system of claim 11, wherein said operational characteristics include event date, event location, partner company name, partner logo, partner signature and partner customer list.

13. The system of claim 12, wherein the portal server is adapted to automatically forward invitations to customer s on the partner customer list regarding the event.

14. The system of claim 13, wherein the portal server automatically tracks responses from said customer s to said invitations.

15. The system of claim 12, wherein the partner interface module is adapted to allow the partner to add additional customer s to the customer list.

16. The system of claim 12, wherein the portal server is adapted to allow customer s to add additional customer s to the customer list.

17. The system of claim 12, wherein the portal server is adapted to send event invitations for printing and delivering to each customer on said partner customer list.

18. The system of claim 12, wherein the portal server is adapted to obtain registered company location from the partner and to send event related materials for printing and delivery to said registered company location.

19. The system of claim 11, wherein the portal server is adapted to allow the vendor to provide a questionnaire to the partner on the portal interface module regarding the quality of event management.

20. The system of claim 11, wherein the portal server is adapted to allow the vendor to provide a questionnaire to the customer regarding the quality of event.
